(19) United States
(12) Patent Application Publication
(10) Pub. No.: US 2017/0032387 A1
(43) Pub. Date: Feb. 2, 2017

(54) APPARATUS AND METHOD FOR ACQUIRING, ANALYZING AND MONITORING DATA

(71) Applicant: MAXFONE S.R.L., Villafranca di Verona (Verona) (IT)

(72) Inventors: Paolo ERRICO, San Giovanni Lupatoto (Verona) (IT); Corrado PRATI, Vigasio (Verona) (IT)

(21) Appl. No.: 14/830,941

(22) Filed: Aug. 20, 2015

(30) Foreign Application Priority Data
Jul. 30, 2015 (IT) 102015000040566

(51) Int. Cl. G06Q 30/02; G06Q 50/00; G06F 17/30

(52) U.S. Cl. CPC G06Q 30/0201; G06F 17/30867; G06Q 50/01

(57) ABSTRACT

The present invention regards a method for acquiring, analyzing and monitoring data, images and/or conversations including the following steps:
selecting at least one argument of interest;
exploring a plurality of web pages;
acquiring the data, images and/or conversations;
analyzing the data, images and/or conversations acquired; and
generating and displaying video signals.

### TECHNICAL FIELD OF THE INVENTION

The present invention regards an apparatus and a method for acquiring, analyzing and monitoring data, images and/or conversations.

### STATE OF THE PRIOR ART

Companies, in evaluating products or fields to be developed, very often turn their attention to the market so as to obtain a confirmation with regard to user interests or opinions.

This can be conducted by means of market investigation, which apart from being rather costly, also provides for execution times on the order of several weeks, if not months in certain cases.

Moreover, such researches are usually conducted by specialized firms, by interviewing by phone or in person a specific number of people; hence, on one hand, the opinions of those interviewed are affected by the environment or context in which they are collected (this is particularly true in the case of interview in person) and, on the other hand, they are limited to the specific quantity of interviews arranged by the company that wishes to obtain the research.

It should then be considered that these investigations are often conducted in a defined geographic area and therefore do not reflect a larger range, i.e. global area, with regard to people's tastes or market trends.

It should also be noted that time passes from the execution of the investigation to the sending of a respective report to the client, and in certain cases, with reference to quickly-evolving sectors, this passing of time could lead to results of little use.

### SUMMARY OF THE INVENTION

One object of the present invention is to provide a new method and a new apparatus for data acquisition, analysis and monitoring.

Another object of the present invention is to provide a method and an apparatus for data acquisition, analysis and monitoring which are capable of providing a reliable reply of the judgment of people on a specific argument.

Another object of the present invention is to provide a method and an apparatus as stated above which allow obtaining data practically in real time.

Another object of the present invention is to provide a new web platform.

In accordance with one aspect of the invention, a method is provided according to the present principles.

In accordance with another aspect of the invention, an apparatus according to the present principles is provided.

The specification further refers to preferred and advantageous embodiments of the invention.

### BRIEF DESCRIPTION OF THE DRAWINGS

Other characteristics and advantages of the invention will be more evident from the description of an embodiment of a method and of an apparatus, illustrated by way of example in the enclosed drawings, in which:

FIG. 1 shows a block diagram of the main steps of the method as well as of the main components of an apparatus according to the present invention; and

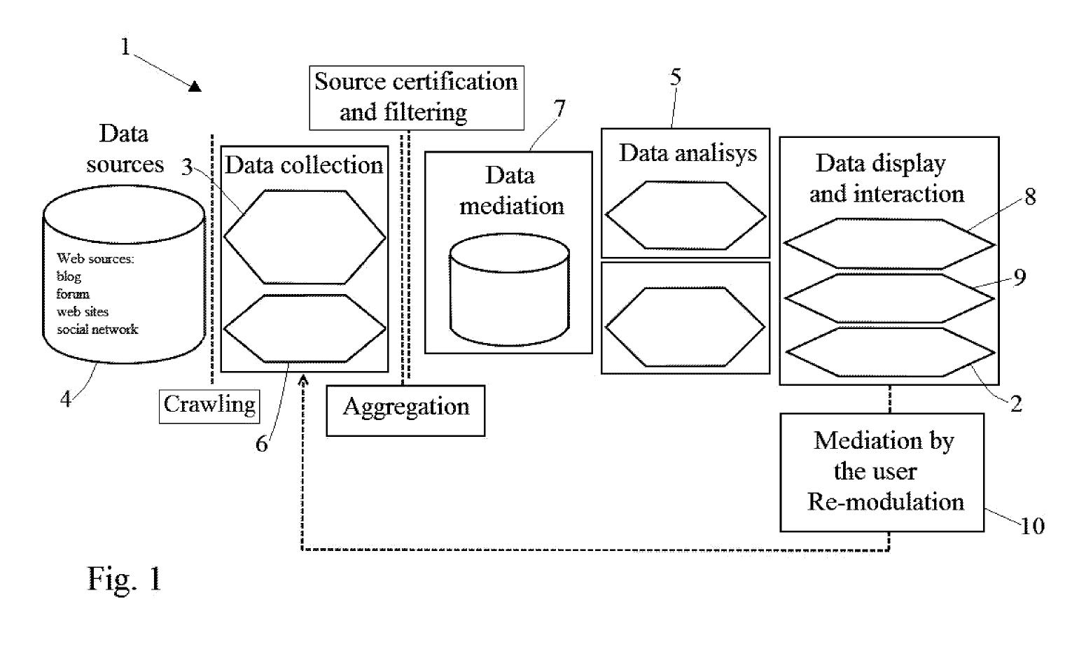

FIG. 2 shows an illustrative map of the users as well as of the communications therebetween and also shows several images displayed by the display unit of an apparatus according to the present invention.

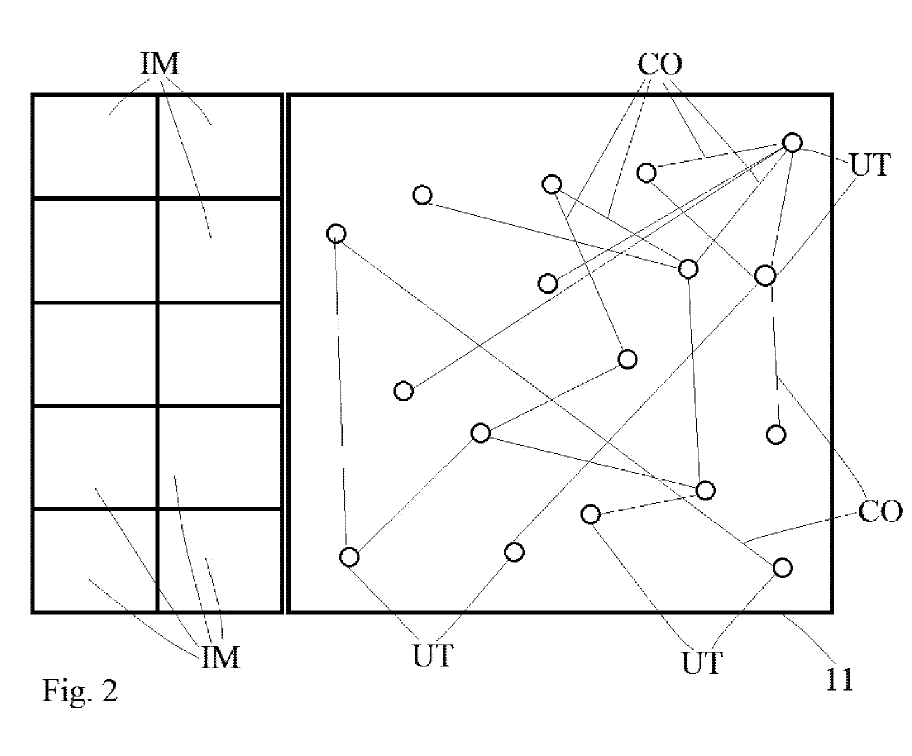

In the enclosed drawings, equivalent parts or components are marked with the same reference numbers.

### DETAILED DESCRIPTION OF THE INVENTION

An apparatus for data acquisition, analysis and monitoring, images and/or conversations 1 according to the present invention, in particular a web platform, comprises a unit 2 for selecting at least one argument of interest, e.g. means for inserting, if desired with keyboard or voice or of another suitable type, key words associated or associable with the argument or with an argument of interest. On the basis whereof, it is only possible to collect the information pertaining to the arguments of interest, e.g. brands or trademarks, products, public personalities, companies, markets, events, etcetera.

The apparatus then comprises a unit 3 for exploring web pages 4 and for acquiring data, images and/or conversations (hereinbelow also only generically indicated with “data”) therefrom; such unit 3 is in communication with the selection unit 2. More particularly, the exploration and acquisition unit 3 is set to obtain data, images and/or conversations relative to the argument of interest and to acquire the data, images and/or conversations thus obtained and then transmit it by means of respective data transmission means. The exploration and acquisition unit 3 is in particular set to explore web pages 4 of social networks (e.g. Facebook, Twitter, Instagram, Google+, etc.) and/or blogs (institutional and/or personal) and/or discussion forums.

By conversations in the present patent application, it is intended conversations between network users or parts of conversations, in particular with reference to the argument of interest.

If desired, the exploration and acquisition unit 3 comprises at least one application programming interface or A.P.I. and/or a search engine set to extract, from the explored web pages, information or photographic content of interest. Through the combined use of the A.P.I. and suitable search engines or crawlers, the information of interest can be detected and extracted, that is published daily by users and organizations throughout the world through different web channels.

The apparatus is then provided with an analysis unit 5 in communication with the transmission means, such that the analysis unit 5 is set to receive the data acquired by the exploration and acquisition unit 3 and to analyze such data, before then emitting first signals representative of the received and analyzed data.

If desired, in the exploration and acquisition unit 3 or between the same and the analysis unit 5, means are provided for filtering 6 the data received by the exploration and acquisition unit 3; such filtering means 6 are set to filter such data and send the filtered data to the analysis unit 5.

The filtering means can include a mediation unit for managing contents; such mediation unit is for example able to allow:
banning or excluding undesired acquired photographs, conversations and/or information;
banning or excluding acquired photographs, conversations and/or information that were created or introduced in the web from undesired sources; and/or
excluding speech, i.e. acquired conversations that contain certain words;
highlighting the most significant acquired information, conversations and/or photographs.

Moreover, the apparatus could also be provided with means for classifying the source or user, for example based on:
category of the source/user, e.g. blogger, journalist, etcetera;
geolocation of the source/user;
number of content or information created by the source/user; and
popularity on the web of the source/user (this will also be discussed hereinbelow).

The apparatus can then be provided with means for generating video signals in communication with the analysis unit 5 or integrated therein, such that the first signals are video signals or are converted into video signals.

At least one component for the homogenization or mediation 7 of the data obtained by the exploration and acquisition unit 3 can then be provided in the apparatus. Such component is set to render such data consistent with a same archiving and/or display system, before sending to the analysis unit 5. For such purpose, it will be observed that the data collected from the different roots or sources often have different structure and hence the same must be integrated and stored in a single archiving system, according to a standard structure.

Advantageously, the filtering means 6 or the analysis unit 5 are set to examine the acquired data in order to evaluate the meaning of the expressions, images or words found therein, as well as eliminate the acquired data or images that are deemed not of interest with reference to the selected argument.

In substance, the collected information or data can be subjected to a filtering based on a semantic tree suitably defined as a function of the arguments of interest; in this manner, all content or data that not relevant and which therefore constitutes noise is excluded.

In the present patent application, by semantic tree it is intended the set of terms or combination of terms, in particular of the same language, that with reasonable probability—settable or selectable for example by means of suitable apparatus introduction means—refer to a specific argument of interest. These terms are defined through an in-depth analysis of the speech or better yet of the acquired and analyzed conversations, and serve to allow contextualizing such conversations, reducing to the minimum the contents not related to the argument of interest.

The creation of a semantic tree is preferably carried out by language or by argument of interest.

Hence, if desired, the analysis unit 5 or filtering means 6 are set to evaluate the level of reliability of the web pages 4 so as to determine the exclusion of contents coming from sources having a reliability level lower than a threshold value, and such threshold value can be set by the user by means of suitable input means. This passage has the purpose of implementing the quality level of the starting information or information that is acquired and processed for obtaining the first signals.

With reference to such aspect, first of all the web sources to be evaluated in relation to the arguments of interest are identified; they are detected and contextualized based on different semantic terms defined and used for research.

The apparatus can then be set to obtain a series of information relative to the presence of the source or user in the web, e.g. by means of research, such as Google PR, Backlinks, RSS feeds; such information is such to express or represent the level of authority, popularity, topicality and/or updating of the source/user. Subsequently, the source/user is identified over various social channels and a whole series of further information is recovered, in particular from Facebook and Twitter, expressing the popularity and the level of interaction generated (by the source/user) in the general public through the main social channels.

Based on all the collected information, also through the use of indices and suitably defined evaluation parameters, a general score is finally established for each source/user, expressing his/her level of reliability.

The apparatus can also be provided with means for examining the frequencies of publication of the data in the web pages 4, if desired with the setting of a filter for origin source, for country, for language and/or for time distribution.

Means can then be provided for evaluating the level of importance of the managers (users or top users) of the web pages 4 related to the argument of interest, so as to operate an advanced subdivision or segmentation of the influential users (influencers) correlated with the arguments of interest. With regard to such aspect, by means of a suitable device or algorithm, it is possible to obtain, from the collected data and information (in particular from the forum discussions), the most influential users (top influencers), based on their reliability and on the information present in their profiles.

The top influencers are those users or those sources of information that have a strong following in the community that interacts in an analyzed conversation, and can be of two types:
content creator, i.e. users who very often insert their observations, comments or photographs in the web, or
mentioned online, i.e. users who are very often mentioned or recalled by other users.

The apparatus can then be provided with means for verifying the generated interaction: use of standard and advanced key performance indicators (internally developed) for evaluating the generated interaction. For such purpose, by generated interaction it is intended a measure aimed to quantify the level (rapidity, frequency, quantity of interventions) with which the user reacts and interacts with the apparatus and with the content published by the same through the social channels.

Means for evaluating the social network can also be provided in the apparatus.

A display unit 8 is then provided in the apparatus, in communication with the video signal generation means and set to display the video signals. The display unit 8 can comprise a monitor or a graphic interface at a specific web address.

If desired, the apparatus is also provided with means for adjusting and setting 9 the parameters of the display unit 8, as well as personalizing the graphic representation structure, by inserting logos, changing the size of the data or images IM displayed. There is then the possibility to incorporate, in the site of a user of the apparatus according to the present invention, a photo banner of a specific logo.

The display unit can also be provided with means for personalizing or adapting the graphical representation of the information or images IM, for example by also providing a series of templates selectable by a user.

With reference to the social network evaluation means, the apparatus or better yet the display unit can provide a graphic representation of the users most connected to the argument of interest and of the links (communications/conversations) between the same. Due to such representation, it is possible to see the manner in which the conversations between the users of the network are developed, indicating the most influential subjects that are more closely correlated to the argument of interest.

More particularly, the analyzed data is represented and displayed in streaming/real time, so as to allow the user of the apparatus or of the method, object of the present patent application, to be always updated with reference to the argument of interest as well as be able to consequently operate even quite rapidly, possibly with communication or marketing actions.

The apparatus can then be provided with means for interacting in the conversations in the explored pages and/or with the most influential users that are more closely correlated to the arguments of interest.

For such purpose, if the apparatus according to the present invention or better yet the display unit thereof is capable of creating a map 11 or structure that identifies or illustrates the users UT or sources, along with the communications or conversations CO between the same, interaction means could be provided that would allow selecting a specific communication CO, e.g. indicated with a line in an identification structure or map 11 and then would allow trying to modify the evolution of the communication or conversation CO, e.g. by sending messages or images to one or more users UT or sources affected or at the basis of the communication, i.e. the users or sources connected by the line.

Moreover, the apparatus 1 can also be set to allow configuring the sending of personalized messages based on the target or objective user/source that it is desired to reach.

If desired, the apparatus can also be provided with means for exporting the acquired data and for emitting summary reports of the steps undertaken.

The apparatus can also be provided with means for exporting, e.g. in a CSV file or a file of another type, all the sources belonging to the category/categories of interest.

A control unit 10 is also provided, which allows setting the parameters of the exploration and acquisition unit 3.

Moreover, in addition to being able to eliminate the acquired data or images that are deemed not of interest, it is possible to mark the (acquired) data or photographic contents that are particularly appreciated as “preferred”.

If desired, an apparatus according to the present invention can be set to collect and represent, in real time, the photographs published online, so as to recover, for example, from the main social networks, all the photographic contents relative to specific arguments of interest through the use of suitable key words and to represent such contents in an interactive manner, through a suitable graphical representation or wall.

Moreover, the apparatus could be provided with means for extrapolating, from the collected conversations or images, sources or users belonging to a specific category, if desired professional, e.g. journalist, blogger, magazine, before then if desired eliminating the communications and images of sources and users not belonging to the selected category, or grouping the communications or images of sources or users of each category separately from the communications or images of sources and users of other categories.

The apparatus can also be provided with means for recognizing the idiom or language used by the source or user with which it is desired to communicate, and it is then provided with means for personalizing or adapting the content or information obtained from such source/user also based on the latter variable.

In accordance with the present invention, a method is also provided for data acquisition, analysis and monitoring, if desired implementable with an apparatus as stated above.

Such method comprises the following steps:
selecting at least one argument of interest, e.g. inserting key words associated or associable with the argument of interest;
exploring a plurality of web pages in order to obtain data relative to the argument of interest;
acquiring the data thus obtained, i.e. obtained during the exploration step;
analyzing and, if desired, filtering the data acquired during the acquisition step; and
generating and displaying video signals representative of the data analyzed during the analysis step and, if desired filtered, e.g. in a monitor or at a specific web address.

The exploration step preferably comprises a step for exploring web pages of social networks (e.g. Facebook, Twitter, Instagram, Google+, etc.) and/or blogs (institutional and/or personal) and/or discussion forums.

The acquisition step can then comprise a step for extracting information or photographic content of interest by means of at least one application programming interface (A.P.I.) and/or at least one search engine.

A step can then be provided for the homogenization or mediation of the obtained data so as to render it consistent with a same archiving and/or display system.

Moreover, a step can be provided for adjusting or setting the parameters of the video signal display.

The filtering step can comprise a step for examining the acquired data in order to evaluate the meaning of the expressions, words or images found therein, as well as a step for eliminating, from the acquired data, data recognized as not of interest during the examination step, for example since it is verified that the expressions, words or images are not actually pertinent to the argument of interest.

Moreover, the filtering step can comprise a step for evaluating the reliability level of the web pages, during which contents are excluded coming from sources having a reliability level less than a threshold value.

If desired, the analysis step comprises at least one of the following steps:
analyzing the frequencies of publication of the data in the web pages, if desired with the setting of a filter for origin source, for country, for language and/or for time distribution; and/or
analyzing the level of importance of the managers of the web pages correlated with the argument of interest; and/or
analyzing the level of importance of the users in the conversations in said web pages correlated with said at least one argument of interest.

If desired, a method according to the present invention also provides for a step of adjusting and setting the display parameters.

More particularly, a method according to the present invention provides for the display in streaming/real time of the acquired and analyzed data.

In such case, the acquired and analyzed information or photographs can then be made available in a few seconds time, e.g. on an active web page that is constantly updated, with the new information or photographs, at pre-established intervals, and for such purpose the apparatus can also be provided with adjustment means set to adjust and establish the time interval between the display of a first group of information or images and the display of a second group of information or images acquired after the first group or to adjust and establish the time between the acquisition of the information or images and the display of images or indications relative thereto.

If desired, the following can then be provided:
a step for interacting in the conversations and/or with the most influential users that are more closely correlated to the arguments of interest;
a step for exporting the obtained data and for emitting summary reports of the steps undertaken;
a control step, during which the parameters of the exploration and acquisition step are set.

Clearly, possibly preferred or advantageous aspects described with reference to the apparatus are to be intended as applicable also with reference to the method, object of the present patent application, or with a respective step thereof, i.e. that a method according to the present invention comprises or can comprise a step corresponding to (i.e. set to perform the functions of) one or more components, units or means of an apparatus according to the present invention.

In substance, an apparatus according to the present invention is a web-based platform for collecting, analyzing and monitoring in real time content present in the web and in particular in the social media, in relation to arguments of interest, which allows collecting, contextualizing and filtering the information of interest from the noise, if desired also in relation to the level of reliability of the sources from which it is retrieved, in order to then subsequently analyze such information and represent it graphically, e.g. through a dashboard.

Such apparatus then allows a user to have a direct interaction, e.g. through different social channels, with content of interest or with the most influential subjects connected to the arguments.

It is thus possible:
to analyze and monitor in real time the web marketplaces, as support for strategic and marketing decisions;
to analyze and monitor in real time the web reputation of arguments of interest connected for example to brands or trademarks, products, personalities, hashtags, etcetera;
to interact directly in the conversations connected to the arguments of interest and with the most influential subjects who operate online, for the implementation of digital communication strategies;
to remodel and personalize the process in an autonomous manner, through the use of different filters and the personalization of the initial search criteria.

The apparatus and the method according to the present invention thus offer a user a complete dashboard for monitoring and interaction, highly personalized as a function of the user's strategic and operative objectives and his/her competencies.

The apparatus and the method thus provide various instruments that allow autonomously defining the criteria for analysis and monitoring and remodeling such criteria at any moment as a function of the changes in the objectives or newly learned information.

Modifications and variants of the invention are possible within the protective scope defined by the claims.

1. A method of acquisition, analysis and monitoring of data, images and/or conversations including the following steps:
selecting at least one argument of interest;
exploring a plurality of web pages in order to obtain data, images and/or conversations relative to said at least one argument of interest;
acquiring data, images and/or conversations obtained during said exploration step;
analyzing the data, images and/or conversations obtained during said acquisition step; and
generating and displaying video signals representative of the data, images and/or conversations analyzed during said analysis step.

2. A method according to claim 1, wherein said exploration step comprises a step of exploring web pages of social networks and/or blogs and/or discussion forums.

3. A method according to claim 1, wherein said acquisition step comprises a step of extracting information, conversations and/or photographic content of interest by means of at least one application programming interface and/or at least one search engine.

4. A method according to claim 1, wherein said selecting step includes a step of inserting keywords associated or associable with said at least one argument of interest.

5. A method according to claim 1, comprising a step of homogenization of said data, images and/or conversations obtained so as to render them consistent with a same archiving and/or display system.

6. A method according to claim 1, wherein said step of displaying is carried out on a monitor or at a specific web address.

7. A method according to claim 1, comprising a step of adjusting and setting the parameters of said video signal display.

8. A method according to claim 1, comprising a step of filtering said acquired data, images and/or conversations.

9. A method according to claim 8, wherein said filtering step comprises a step of examining said acquired data, images and/or conversations in order to evaluate the meaning of the expressions or words or images foundable in them, as well as a step of eliminating from said acquired data, images and/or conversations acquired data, images and/or conversations which in said step of examining are deemed not of interest with respect to the selected argument.

10. A method according to claim 9, wherein said filtering step comprises a step of evaluating the reliability level of said web pages during which step of evaluating contents are excluded that originate from sources having a reliability level less than a threshold value.

11. A method according to claim 1, wherein said analysis step comprises at least one of the following steps:
analyzing the frequencies of publication of said data, images and/or conversations in said web pages, possibly with the setting of a filter for origin source, for country, for language and/or for time distribution; and/or
analyzing the level of importance of the managers of said web pages correlated to said at least one argument of interest; and/or
analyzing the level of importance of the users in the conversations in said web pages correlated to said at least one argument of interest.

12. A method according to claim 1, wherein the analyzed data, images and/or conversations are displayed in real time.

13. A method according to claim 1, including a step of interacting in conversations in the explored web pages and/or with the users most influential and more closely correlated with the arguments of interest.

14. A method according to claim 1, comprising a step of exporting the acquired data, images and/or conversations and of emitting summary reports of the steps undertaken.

15. An apparatus for acquisition, analysis and monitoring of data, images and/or conversations comprising:
a unit for selecting at least one argument of interest;
a unit for exploring web pages and for acquiring data, images and/or conversations therefrom, said unit of exploration and acquisition being in communication with said selection unit, said unit of exploration and acquisition being set to obtain data, images and/or conversations relative to said at least one argument of interest and to acquire data, images and/or conversations so obtained, said unit of exploration and acquisition comprising means for the transmission of the acquired data, images and/or conversations;
an analysis unit in communication with said transmission means, so that said analysis unit is set to receive said data, images and/or conversations acquired by said exploration and acquisition unit and to analyze such data, images and/or conversations and then issue first signals representative of the received and analyzed data, images and/or conversations;
a display unit in communication with said analysis unit and set to display video signals corresponding to said first signals or obtained by conversion of said first signals.

16. An apparatus according to claim 15, wherein said exploration and acquisition unit is set to explore web pages of social networks and/or blogs and/or discussion forums.

17. An apparatus according to claim 15, wherein said exploration and acquisition unit comprises at least one application programming interface and/or at least one search engine set to extract from explored web pages information, conversations and/or photographic contents of interest.

18. An apparatus according to claim 15, wherein said selection unit includes means for entering keywords associated or associable with said at least one argument of interest.

19. An apparatus according to claim 15, comprising at least one component of homogenization or mediation of data, images and/or conversations obtained from said exploration and acquisition unit, said at least one homogenization or mediation component being responsible for rendering such data, images and/or conversations consistent with a same archiving and/or display system.

20. An apparatus according to claim 15, wherein said display unit comprises at least one monitor or one graphic interface at a specific web address.

21. An apparatus according to claim 15, comprising means for adjusting and setting the parameters of said display unit.

22. An apparatus according to claim 15, comprising, in said exploration and acquisition unit or between said exploration and acquisition unit and said analysis unit, filtering means of the data, images and/or conversations received from said exploration and acquisition unit, said filtering means being set to filter such data, images and/or conversations and for sending the filtered data, images and/or conversations to said analysis unit.

23. An apparatus according to claim 22, wherein said filtering means and/or said analysis unit are set to examine the acquired data, images and/or conversations in order to evaluate the meaning of the expressions, images or words foundable therein, and to eliminate the acquired data, images and/or conversations that are deemed not of interest with respect to the selected argument.

24. An apparatus according to claim 22, wherein said filtering means and/or said analysis unit are intended to evaluate the level of reliability of said web pages so as to determine the exclusion of contents coming from sources having a reliability level less than a threshold value.

25. An apparatus according to claim 15, comprising:
means for examining the frequencies of publication of the data, images and/or conversations in the web pages, possibly with the setting of a filter for source of origin, for country, for language and/or for time distribution; and/or
means of evaluating the level of importance of the managers of the web pages related to the argument of interest, so as to operate an advanced subdivision or segmentation of the influential users correlated with the arguments of interest.

26. An apparatus according to claim 15, wherein the analyzed data, images and/or conversations are represented and displayed in real time.

27. An apparatus according to claim 15, including means of interaction in the conversations and/or with the users most influential and most correlated with the arguments of interest.

28. An apparatus according to claim 15, comprising means of exporting the acquired data, images and/or conversations and of releasing summary reports of the performed steps.
